(19) United States
(12) Patent Application Publication
(10) Pub. No.: US 2025/0294369 A1
(43) Pub. Date: Sep. 18, 2025

(54) INFORMATION PROCESSING APPARATUS, INFORMATION PROCESSING METHOD, INFORMATION PROCESSING SYSTEM, AND STORAGE MEDIUM

(71) Applicant: NEC Corporation, Minato-ku, Tokyo (JP)

(72) Inventors: Hideki KIKKAWA, Tokyo (JP); Takashi TONEGAWA, Tokyo (JP); Kazuki OGATA, Tokyo (JP); YUJI SATO, Tokyo (JP); Jun TAKASAWA, Tokyo (JP); Kosei KOBAYASHI, Tokyo (JP)

(73) Assignee: NEC Corporation, Minato-ku, Tokyo (JP)

(21) Appl. No.: 18/862,202

(22) PCT Filed: May 11, 2022
(86) PCT No.: PCT/JP2022/019887

§ 371 Date: Nov. 1, 2024

(51) Int. Cl. H04W 16/18; G06T 7/70

(52) U.S. Cl. CPC H04W 16/18; G06T 7/70; G06T 2207/10028

(57) ABSTRACT

To output information for removing a radio blind spot in wireless communication, an information processing apparatus (1) includes: an obtaining section (11) that obtains first data and second data, the first data indicating objects included in a first angle of field in which a first base point is set at a location at which quality of communication with a base station is not more than a predetermined threshold, the second data indicating objects included in a second angle of field in which a second base point is set at the base station; a calculation section (12) that calculates one or more locations each indicated by a corresponding one of one or more objects each indicated in common by both the first data and the second data; and an output section (13) that outputs at least one of the one or more locations calculated by the calculation section (12).

### TECHNICAL FIELD The present invention relates to a technique for wireless communication.

### BACKGROUND ART

Attempts have been made to perform high-speed communication by using radio waves having short wavelengths such as millimeter waves. Because such a radio wave having a short wavelength has a high rectilinear propagation property, which is likely to generate a blind spot, a reflector is placed to remove such a blind spot. For example, Patent Literature 1discloses that a reflector formed of a metal plate or the like is provided in a relay machine, and a radio wave (e.g., a millimeter wave) transmitted from a data collector are reflected by the reflector, to relay the transmission of user data from the data collector to a ground machine. Further, Patent Literature 1discloses a method of controlling the location of the relay machine. In the method, the line-of-sight state between the data collector and the relay machine is determined based on location information of the data collector, location information of the relay machine, information on the communication status between the data collector and the relay machine, and information on the communication status between the relay machine and the ground machine. Then, the location of the relay machine is controlled so as to secure a line of sight between the data collector and the relay machine.

### CITATION LIST

### Patent Literature

### [Patent Literature 1]

Japanese Patent Application Publication Tokukai No. 2018-165099

### SUMMARY OF INVENTION

### Technical Problem

However, it is difficult to determine where to install a reflector in order to efficiently remove a blind spot. Even with the technique disclosed in Patent Literature 1, it is difficult to remove a radio blind spot based on the location information and the information on the communication status.

An example aspect of the present invention has been made in view of this problem, and an example object thereof is to provide a technique for outputting information for removing a radio blind spot in wireless communication.

### Solution to Problem

An information processing apparatus in accordance with an example aspect of the present invention includes: obtaining means for obtaining first data and second data, the first data indicating a plurality of objects included in a first angle of field in which a first base point is set at a location at which quality of communication with a base station is not more than a predetermined threshold, the second data indicating a plurality of objects included in a second angle of field in which a second base point is set at the base station; calculation means for calculating one or more locations each indicated by a corresponding one of one or more objects each indicated in common by both the first data and the second data; and output means for outputting at least one of the one or more locations calculated by the calculation means.

An information processing method in accordance with an example aspect of the present invention includes: obtaining, by at least one processor, first data and second data, the first data indicating a plurality of objects included in a first angle of field in which a first base point is set at a location at which quality of communication with a base station is not more than a predetermined threshold, the second data indicating a plurality of objects included in a second angle of field in which a second base point is set at the base station; calculating, by the at least one processor, one or more locations each indicated by a corresponding one of one or more objects each indicated in common by both the first data and the second data; and outputting, by the at least one processor, at least one of the one or more calculated locations.

An information processing program in accordance with an example aspect of the present invention causes a computer to carry out: an obtaining process of obtaining first data and second data, the first data indicating a plurality of objects included in a first angle of field in which a first base point is set at a location at which quality of communication with a base station is not more than a predetermined threshold, the second data indicating a plurality of objects included in a second angle of field in which a second base point is set at the base station; a calculation process of calculating one or more locations each indicated by a corresponding one of one or more objects each indicated in common by both the first data and the second data; and an output process of outputting at least one of the one or more locations calculated in the calculation process.

### Advantageous Effects of Invention

According to an example aspect of the present invention, it is possible to output information for removing a radio blind spot in wireless communication.

### BRIEF DESCRIPTION OF DRAWINGS

FIG. 1 is a block diagram illustrating the configuration of an information processing apparatus in accordance with a first example embodiment.

FIG. 2 is a flowchart illustrating the flow of an information processing method in accordance with the first example embodiment.

FIG. 3 is a block diagram illustrating the configuration of an information processing apparatus in accordance with a second example embodiment.

FIG. 4 is a diagram for describing an example of the operation of an information processing apparatus.

FIG. 5 is a diagram illustrating an example of a screen presented by a presentation section.

FIG. 6 is a block diagram illustrating the configuration of an information processing system in accordance with the second example embodiment.

FIG. 7 is a diagram illustrating an example of the operation of an information processing system.

FIG. 8 is a diagram illustrating an example of a computer that executes instructions of a program which is software implementing the functions of the apparatuses in accordance with the example embodiments of the present invention.

### EXAMPLE EMBODIMENTS

### First Example Embodiment

The following description will discuss a first example embodiment of the present invention in detail with reference to the drawings. The present example embodiment is a basic form of example embodiments described later.

### Configuration of Information Processing Apparatus

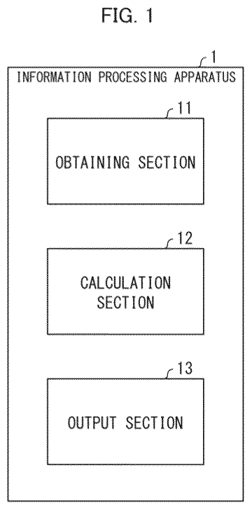

The following description will discuss the configuration of an information processing apparatus 1 in accordance with the present example embodiment with reference to FIG. 1. FIG. 1 is a block diagram illustrating the configuration of the information processing apparatus 1. The information processing apparatus 1 includes an obtaining section 11, a calculation section 12, and an output section 13.

### (Obtaining Section)

The obtaining section 11 obtains first data and second data. The first data indicates a plurality of objects included in a first angle of field in which a first base point is set at a location at which quality of communication with a base station is not more than a predetermined threshold. The second data indicates a plurality of objects included in a second angle of field in which a second base point is set at the base station.

Here, the threshold of the communication quality may be, for example, a threshold of the packet loss rate or a threshold of the radio field intensity. However, the threshold of the communication quality is not limited to these examples, but may be any other threshold related to the communication quality.

### (First Data and Second Data)

As described above, the first data is data indicating a plurality of objects included in the first angle of field at the first base point. The first data may be, for example, sensing data obtained at the first base point. The sensing data may include, for example, imaging data captured at the first base point or sensing data by LiDAR (Light Detection and Ranging, Laser Imaging Detection and Ranging). Here, the first sensing data may include point cloud data obtained at the first base point.

As described above, the second data is data indicating a plurality of objects included in the second angle of field at the second base point. The second data may be, for example, sensing data obtained at the second base point. The sensing data may include, for example, imaging data captured at the second base point or sensing data by LiDAR. Here, the second sensing data may include point cloud data obtained at the second base point.

The first data and the second data are not limited to sensing data, and may be three-dimensional model data. The first data and the second data may be, for example, three-dimensional geospatial data (3D city model etc.), which represents an actual city in a virtual space. In this case, each of the first data and the second data may be, for example, data representing characteristics of a plurality of objects. More specifically, for example, each of the first data and the second data may be data in which information on material and age of building is described in a markup language for each building included in the three-dimensional space.

### (Angle of Field)

Here, the expression “angle of field” is not limited to a case of obtaining images, and may also refer to a predetermined area defined by setting a base point at a certain location. Further, in a case where it is configured so that sensing is carried out by using an electromagnetic wave with high rectilinear propagation properties such as visible light and a laser, the angle of field may be defined as a cone-shaped area with a vertex set as the base point of sensing. However, this is not intended to limit the present example embodiment. In a case where a radio wave transmitted from the base station has directivity, the second angle of field may be, for example, an area included in an angle that is within a predetermined range depending on the transmission direction of the radio wave.

### (Object)

Each object may be included in the first angle of field or the second angle of field, and examples of the object may include a building, an intersection, a parking lot, a park, a traffic light, and the like in an urban area. However, the object are not limited to these examples, but may be any other one.

The obtaining section 11 may obtain the first data and the second data by receiving them from another apparatus connected via a communication channel, or alternatively, the obtaining section 11 may obtain the first data and the second data inputted through an input apparatus connected to an input interface. The obtaining section 11 may be obtained the first data and the second data by reading them from a predetermined storage.

### (Calculation Section)

The calculation section 12 calculates one or more locations each indicated by a corresponding one of one or more objects each indicated in common by both the first data and the second data. For example, in a case where the first data and the second data are both image data, the calculation section 12 may detect an object in both the first data and the second data by using an object detection technique such as Faster R-CNN (Regional CNN), YOLO (You Only Look Once), etc., to calculate a location indicated by the object indicated in common by both the first data and the second data. As another example, the calculation section 12 may detect, for example, an object by subjecting image data to image processing such as pattern matching. Further, for example, in a case where the first data and the second data are both three-dimensional model data, the calculation section 12 may calculate, for example, a location indicated by an object included in common in both the first data and the second data. However, the technique for calculating one or more locations by the calculation section 12 is not limited to the foregoing examples, and the calculation section 12 may calculate one or more locations by any other method.

### (Output Section 13)

The output section 13 outputs at least one of the one or more locations calculated by the calculation section 12. For example, the output section 13 may transmit information indicating one or more locations to another apparatus connected via a communication channel, to output the information, or alternatively, the output section 13 may output the information to an output apparatus connected to an output interface. Here, examples of the output apparatus may include a display, a printer, a projector, and a speaker. The output section 13 may output the information by writing the information in a predetermined storage.

The information outputted by the output section 13 may be, for example, used for installation of a radio reflector or a radio relay apparatus for removing a radio blind spot. In a case where a radio reflector is installed at each of one or more locations outputted by the output section 13, each radio reflector reflects a radio wave transmitted from the base station to make the radio wave reach a location which is the first base point. Thus, it is possible to improve the communication quality at the location which is the first base point. Further, in a case where a radio relay apparatus is installed at each of one or more locations outputted by the output section 13, each radio relay apparatus relays a radio wave transmitted from the base station to make the radio wave reach a location which is the first base point. Thus, it is possible to improve the communication quality at the location which is the first base point.

As described in the foregoing, the information processing apparatus 1 in accordance with the present example embodiment employs a configuration including: the obtaining section 11 that obtains first data and second data, the first data indicating a plurality of objects included in a first angle of field in which a first base point is set at a location at which quality of communication with a base station is not more than a predetermined threshold, the second data indicating a plurality of objects included in a second angle of field in which a second base point is set at the base station; the calculation section 12 that calculates one or more locations each indicated by a corresponding one of one or more objects each indicated in common by both the first data and the second data; and the output section 13 that outputs at least one of the one or more locations calculated by the calculation section 12. Thus, with the information processing apparatus 1 in accordance with the present example embodiment, it is possible to achieve an example advantage of being capable of outputting information for removing a radio blind spot in wireless communication.

### Information Processing Program

The abovementioned functions of the information processing apparatus 1 may be implemented by a program. An information processing program in accordance with the present example embodiment causes a computer to carry out: an obtaining process of obtaining first data and second data, the first data indicating a plurality of objects included in a first angle of field in which a first base point is set at a location at which quality of communication with a base station is not more than a predetermined threshold, the second data indicating a plurality of objects included in a second angle of field in which a second base point is set at the base station; a calculation process of calculating one or more locations each indicated by a corresponding one of one or more objects each indicated in common by both the first data and the second data; and an output process of outputting at least one of the one or more locations calculated in the calculation process.

### Flow of Information Processing Method

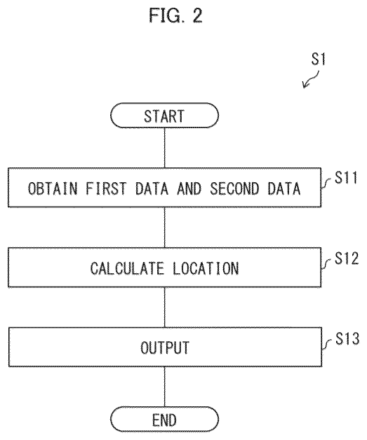

The following description will discuss the flow of an information processing method S1 in accordance with the present example embodiment with reference to FIG. 2. FIG. 2 is a flowchart illustrating the flow of the information processing method S1. It should be noted that steps of the information processing method S1 may be carried out by a processor of the information processing apparatus 1 or by a processor of another apparatus. Alternatively, the steps may be carried out by processors provided in respective different apparatuses.

In step S11, at least one processor obtains first data and second data. The first data indicates a plurality of objects included in a first angle of field in which a first base point is set at a location at which quality of communication with a base station is not more than a predetermined threshold. The second data indicates a plurality of objects included in a second angle of field in which a second base point is set at the base station. In step S12, the at least one processor calculates one or more locations each indicated by a corresponding one of one or more objects each indicated in common by both the first data and the second data. In step S13, the at least one processor outputs at least one of the one or more calculated locations.

### Example Advantage of Information Processing Method

As described in the foregoing, the information processing method S1 in accordance with the present example embodiment employs a configuration including: obtaining, by at least one processor, first data and second data, the first data indicating a plurality of objects included in a first angle of field in which a first base point is set at a location at which quality of communication with a base station is not more than a predetermined threshold, the second data indicating a plurality of objects included in a second angle of field in which a second base point is set at the base station; calculating, by the at least one processor, one or more locations each indicated by a corresponding one of one or more objects each indicated in common by both the first data and the second data; and outputting, by the at least one processor, at least one of the one or more calculated locations. Thus, with the information processing method S1 in accordance with the present example embodiment, it is possible to achieve an example advantage of being capable of outputting information for removing a radio blind spot in wireless communication.

### Second Example Embodiment

The following description will discuss in detail a second example embodiment of the present invention with reference to the drawings. It should be noted that any constituent element that is identical in function to a constituent element described in the first example embodiment will be given the same reference symbol, and a description thereof will not be repeated.

### Configuration of Information Processing Apparatus

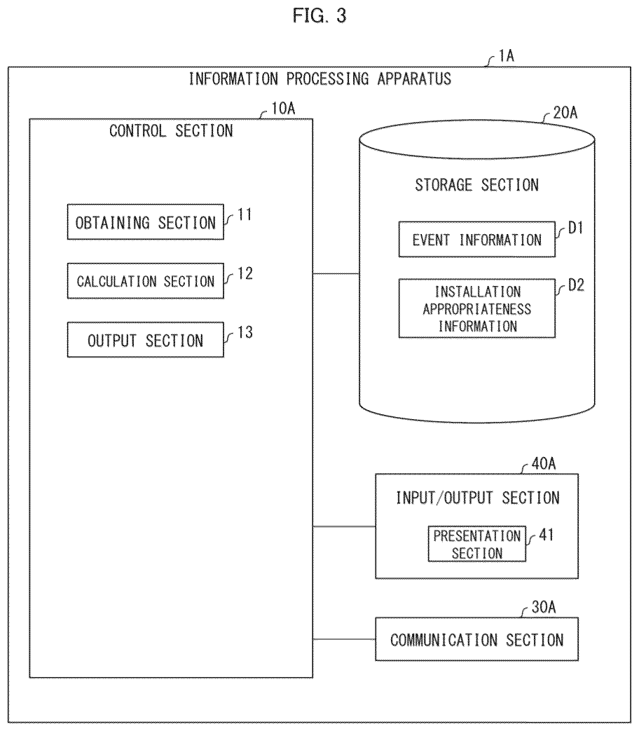

FIG. 3 is a block diagram illustrating the configuration of an information processing apparatus 1A in accordance with the second example embodiment. The information processing apparatus 1A includes a control section 10A, a storage section 20A, a communication section 30A, and an input/output section 40A.

### (Communication Section)

The communication section 30A communicates with an apparatus external to the information processing apparatus 1A via a communication channel. The present example embodiment is not limited to a specific configuration of the communication channel, and examples of the communication channel may include a wireless local area network (LAN), a wired LAN, a wide area network (WAN), a public network, a mobile data communication network, and a combination thereof. The communication section 30A transmits data provided by the control section 10A to another apparatus and provides data received from another apparatus to the control section 10A.

### (Input/Output Section)

To the input/output section 40A, an input/output apparatus such as a keyboard, a mouse, a display, a printer, and a touch panel is connected. The input/output section 40A receives input of various kinds of information to the information processing apparatus 1A from a connected input apparatus. Further, the input/output section 40A outputs various kinds of information to an output apparatus connected thereto, under the control of the control section 10A. Examples of the input/output section 40A may include an interface such as universal serial bus (USB).

### (Control Section and Obtaining Section)

The control section 10A includes an obtaining section 11, a calculation section 12, and an output section 13. The obtaining section 11 obtains first data and second data.

### (First Data)

The first data is data indicating a plurality of objects included in a first angle of field in which a first base point is set at a location at which the quality of communication with the base station is not more than a predetermined threshold. Here, since the first base point is set at the location at which the quality of communication is not more than the predetermined threshold, the first base point may also be a location included in a radio blind spot.

The first data may include, for example, first sensing data obtained at the first base point. Here, the first sensing data may include, for example, first imaging data captured at the first base point. Here, the first sensing data may include, for example, first point cloud data captured at the first base point.

In a case where the first data includes the first imaging data, the first imaging data may be data obtained by capturing with a camera mounted in a vehicle such as a passenger car, or alternatively, the first imaging data may be imaging data obtained by capturing with a camera mounted on a user terminal such as a smartphone carried by a user. Here, the camera for outputting the first imaging data may be, for example, a camera having a wide angle of field, a pan-tilt-zoom camera capable of changing an imaging range, or the like. The first imaging data may be a satellite image. The first imaging data may be still image data, or may be moving image data. Further, the number of the camera for generating the first imaging data may be one, or alternatively, may be two or more.

Further, the first data is not limited to sensing data, but may be any other data. For example, the first data may be three-dimensional model data.

### (Risk Event)

The obtaining section 11 may obtain, for example, the first data related to a location associated with an event caused in a case where the quality of communication decreases to or below a threshold. Hereunder, an event caused by a decrease in communication quality to or below a threshold is also referred to as a “risk event”. For example, the risk event may include cutting out of sound in voice communication, video distortion of streamed video, traffic accidents, and errors in the automatic operation of passenger cars. However, the risk event is not limited to these examples, and may be any other event. The risk event and the communication quality are associated with each other in event information D1 stored in the storage section 20A. Further, the first base point is associated with the risk event or the communication quality in the event information D1. For example, the obtaining section 11 may refer to the event information D1 and may obtain, as the first data, imaging data captured at the first base point associated with the risk event.

Further, in the present example embodiment, the obtaining section 11 obtains the first data related to each of a plurality of the first base points. For example, the obtaining section 11 may obtain the first data related to a plurality of the first base points associated with a single risk event, or alternatively, the obtaining section 11 may obtain first data related to each of a plurality of the first base points associated with the respective risk events.

### (Second Data)

The second data is data indicating a plurality of objects included in the second angle of field in which a second base point is set at the base station. Here, the second angle of field may be, for example, a range in which the communication quality of a radio wave transmitted from the base station is more than a predetermined threshold. The second data may include, for example, second sensing data obtained at the second base point. Here, the second sensing data may include, for example, second imaging data captured at the second base point. More specifically, the second data may be imaging data that represents an image captured during installation of an antenna of the base station. Here, the second sensing data may include, for example, second point cloud data obtained at the second base point.

Further, the second data is not limited to sensing data, but may be any other data. For example, the second data may be three-dimensional model data.

### (Obtained Timing)

The obtaining section 11 may obtain the first data and the second data in real time, or alternatively, the obtaining section 11 may obtain the first data and the second data accumulated in a predetermined server at a timing at which a predetermined condition is satisfied. More specifically, for example, the obtaining section 11 may obtain the first imaging data and the second imaging data in real time from an image capturing apparatus disposed at the first base point and an image capturing apparatus disposed in the base station, respectively. The obtaining section 11 may obtain the first imaging data and the second imaging data from an existing system (e.g., Google Maps (registered trademark)) in which imaging data is accumulated.

### (Installation Appropriateness Information)

Further, in the present example embodiment, the obtaining section 11 further obtains radio reflector installation appropriateness information or radio relay apparatus appropriateness information. Here, the radio reflector installation appropriateness information is information indicating whether or not it is appropriate to install a radio reflector. The radio relay apparatus appropriateness information is information indicating whether or not it is appropriate to install a radio relay apparatus. In the following description, the radio reflector installation appropriateness information and the radio relay apparatus appropriateness information are also referred to as “installation appropriateness information”.

### (Calculation Section)

The calculation section 12 calculates one or more locations each indicated by a corresponding one of one or more objects each indicated in common by both the first data and the second data. A technique for determining, by the calculation section 12, one or more locations each indicated by a corresponding one of one or more objects each indicated in common by both the first data and the second data is the same as the technique described above in the first example embodiment, so that the description thereof will not be repeated here.

Further, in the present example embodiment, the calculation section 12 calculates one or more locations each of which is indicated by a corresponding one of one or more objects each indicated in common by both the first data and the second data, and each of which satisfies a predetermined constraint condition.

### (Constraint Condition)

The constraint condition is a condition referred to in the calculation process of a location. The constraint condition may include, for example, a condition that the distance between a location indicated by a corresponding one of the one or more objects and the first base point is not more than a predetermined distance. In this case, the calculation section 12 selects, from among the one or more locations each indicated by the corresponding one of the one or more objects each indicated in common by both the first data and the second data, a location at which the distance to the first base point is not more than the predetermined distance. Here, the location calculated by the calculation section 12 may be, for example, a position in a three-dimensional space represented by the x-axis, the y-axis, and the z-axis.

The constraint condition may include, for example, a condition that the distance between a location indicated by a corresponding one of the one or more objects and the base station is not more than a predetermined distance. In this case, the calculation section 12 selects, from among the one or more locations each indicated by the corresponding one of the one or more objects each indicated in common by both the first data and the second data, a location at which the distance to the base station is not more than a predetermined distance.

Further, the constraint condition may include, for example, a condition that a location indicated by a corresponding one of the one or more objects is a location indicated to be acceptable in the radio reflector installation appropriateness information or the radio relay apparatus appropriateness information. In this case, the calculation section 12 selects, from among the one or more locations each indicated by the corresponding one of the one or more objects each indicated in common by both the first data and the second data, a location indicated to be acceptable in the installation appropriateness information.

Further, the constraint condition may include, for example, a condition that the one or more locations are calculated such that the number of the one or more locations is minimized. In this case, for example, the calculation section 12 may select, from among the one or more locations each indicated by the corresponding one of the one or more objects each indicated in common by both the first data and the second data, one or more locations such that the number of the locations to be calculated for a plurality of first base points is minimized. More specifically, for example, the calculation section 12 may select, from among a plurality of locations calculated for one first base point, one or more locations each calculated in common for another first base point.

### (Output Section and Presentation Section)

The output section 13 outputs at least one of the one or more locations calculated by the calculation section 12. The input/output section 40A includes a presentation section 41. The presentation section 41 presents at least one of the one or more locations calculated by the calculation section 12 as a radio reflector installation candidate location or a radio relay apparatus candidate location. In the present example embodiment, the output section 13 and the presentation section 41 constitute presentation means in accordance with the present example embodiment. For example, the location presented by the presentation section 41 may be used in the installation of a radio reflector or a radio relay apparatus for eliminating a radio blind spot. Here, the radio reflector may be made of, for example, a material suitable for reflecting millimeter waves. The radio reflector may be, for example, a film-like member.

### (Storage Section)

The storage section 20A stores event information D1 and installation appropriateness information D2. The event information D1 is information in which a risk event and a communication quality are associated with each other. The installation appropriateness information D2 includes one or both of the radio reflector installation appropriateness information and the radio relay apparatus appropriateness information obtained by the obtaining section 11.

### Example of Operation of Information Processing Apparatus

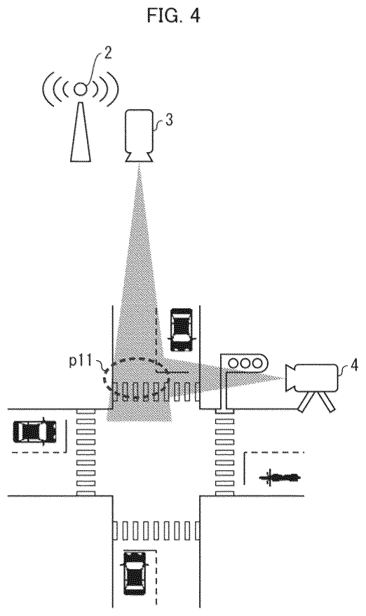

FIG. 4 is a diagram for describing an example of the operation of the information processing apparatus 1A. In the example of FIG. 4, an image capturing apparatus 4 captures an image from a first base point at which the quality of communication with the base station 2 becomes not more than a predetermined threshold. Further, an image capturing apparatus 3 captures an image from the base station 2. In this case, in other words, the first data obtained by the obtaining section 11 includes first imaging data captured by the image capturing apparatus 4 from the first base point, and the second data includes second imaging data captured by the image capturing apparatus 3 from the base station 2.

The calculation section 12 subjects the first imaging data and the second imaging data to a process such as an object detection process, to detect an object included in common in both the first imaging data and the second imaging data, to thereby calculate a location of the detected object. In the example of FIG. 4, the calculation section 12 calculates location p11 as a location included in common in both the first imaging data and the second imaging data. The presentation section 41 presents the location p11 calculated by the calculation section 12.

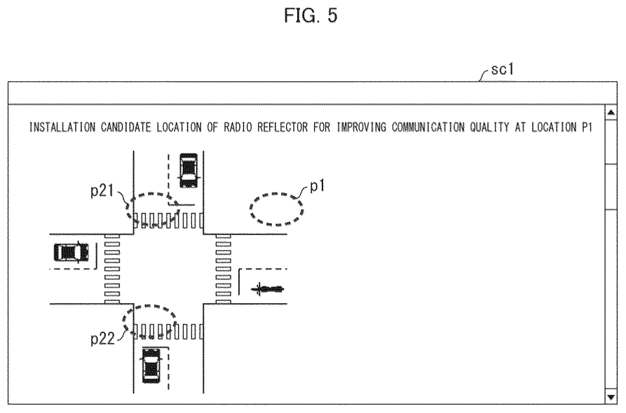

FIG. 5 is a diagram illustrating an example of a screen presented by the presentation section 41. In FIG. 5, a screen sc1 displays location p1, which is the first base point, and candidate locations p21 and p22 for installing a radio reflector or a radio relay apparatus. By checking the screen presented by the presentation section 41, the user of the information processing apparatus 1A can ascertain an appropriate location to place a radio reflector or a radio relay apparatus.

As described above, in the example of FIGS. 4 and 5, the information processing apparatus 1A compares an image obtained by capturing from the base station 2 with an image obtained by capturing from a first location (radio blind spot) at which the communication quality is not more than a threshold, to calculate and present a location included in common in both the images. The location included in common in both the images is a location where installing a radio reflector or a radio relay apparatus can eliminate the radio blind spot. According to the present example embodiment, presenting this location allows the user to appropriately dispose a radio reflector or a radio relay apparatus, resulting in elimination of the radio blind spot. In particular, although a radio wave having a high rectilinear propagation property, such as a millimeter wave, is likely to generate a radio blind spot, it is possible to more suitably eliminate the radio blind spot with the present example embodiment.

### Configuration of Information Processing System

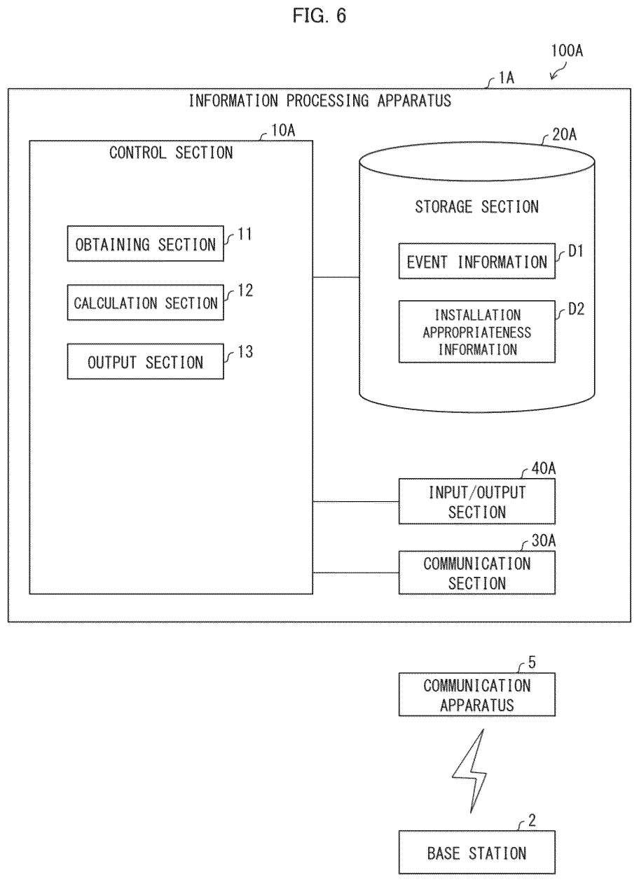

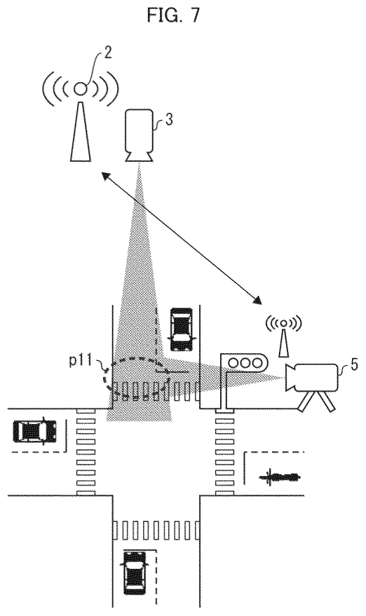

FIG. 6 is a block diagram illustrating the configuration of an information processing system 100A in accordance with the second example embodiment, and FIG. 7 is a diagram for describing an example of the operation of the information processing system 100A. The information processing system 100A includes the information processing apparatus 1A and a communication apparatus 5 configured to be capable of communicating with the base station 2. Here, examples of the communication apparatus 5 may include a terminal mounted in a vehicle such as an automobile, a user terminal such as a smartphone owned by a user, and a security camera installed in an urban area. The communication apparatus 5 may be a stationary apparatus installed at a certain location or may be a movable apparatus mounted in a vehicle or the like.

In the information processing system 100A, the obtaining section 11 obtains first data and second data in a case where the quality of communication between the base station 2 and the communication apparatus 5 is not more than a threshold. In this case, the first base point may be set at, for example, a location where the communication apparatus 5 is placed. The obtaining section 11 may obtain imaging data captured and generated by the communication apparatus 5 as the first data, or alternatively, may obtain the first data from another apparatus. In the example of FIG. 7, the calculation section 12 calculates location p11 as a location included in common in both the first data and the second data.

### Example Advantages of Information Processing Apparatus 1A

As described in the foregoing, the information processing apparatus 1A in accordance with the present example embodiment employs a configuration in which the first data includes first sensing data obtained at the first base point, and the second data includes second sensing data obtained at the second base point. Thus, according to the information processing apparatus 1A in accordance with the present example embodiment, it is possible to achieve an example advantage of being capable of outputting more accurate information as information for removing a radio blind spot by using data obtained by sensing, in addition to the example advantage achieved by the information processing apparatus 1 in accordance with the first example embodiment.

The information processing apparatus 1A in accordance with the present example embodiment also employs a configuration in which the first sensing data includes first imaging data captured at the first base point; and the second sensing data includes second imaging data captured at the second base point. Thus, according to the information processing apparatus 1A in accordance with the present example embodiment, it is possible to achieve an example advantage of being capable of outputting more accurate information as information for removing a radio blind spot by using imaging data obtained by image-capturing, in addition to the example advantage achieved by the information processing apparatus 1 in accordance with the first example embodiment.

The information processing apparatus 1A in accordance with the present example embodiment also employs a configuration in which the first sensing data includes first point cloud data obtained at the first base point; and the second sensing data includes second point cloud data obtained at the second base point. Thus, according to the information processing apparatus 1A in accordance with the present example embodiment, it is possible to achieve an example advantage of being capable of outputting more accurate information as information for removing a radio blind spot by using sensing data including point cloud data, in addition to the example advantage achieved by the information processing apparatus 1 in accordance with the first example embodiment.

The information processing apparatus 1A in accordance with the present example embodiment also employs a configuration in which the obtaining section 11 obtains the first data related to a location associated with an event caused in a case where the quality of communication decreases to or below the threshold. Thus, according to the information processing apparatus 1A in accordance with the present example embodiment, it is possible to achieve an example advantage of being capable of outputting information for removing a blind spot of a radio wave received at a location associated with an event caused due to a decrease in communication quality, in addition to the example advantage achieved by the information processing apparatus 1 in accordance with the first example embodiment.

The information processing apparatus 1A in accordance with the present example embodiment also employs a configuration in which the output section 13 includes the presentation section 41 that presents at least one of the one or more locations calculated by the calculation section 12 as a radio reflector installation candidate location or a radio relay apparatus candidate location. Thus, according to the information processing apparatus 1A in accordance with the present example embodiment, it is possible to achieve an example advantage of being capable of presenting an installation candidate location of a radio reflector or a radio relay apparatus for removing a radio blind spot in wireless communication, in addition to the example advantage achieved by the information processing apparatus 1 in accordance with the first example embodiment.

The information processing apparatus 1A in accordance with the present example embodiment also employs a configuration in which the calculation section 12 calculates one or more locations each of which is indicated by a corresponding one of one or more objects each indicated in common by both the first data and the second data, and each of which satisfies a predetermined constraint condition. Thus, according to the information processing apparatus 1A in accordance with the present example embodiment, it is possible to achieve an example advantage of being capable of outputting, as information for removing a radio blind spot, a location that satisfies the constraint condition, in addition to the example advantage achieved by the information processing apparatus 1 in accordance with the first example embodiment.

The information processing apparatus 1A in accordance with the present example embodiment also employs a configuration in which the constraint condition includes a condition that a distance between a location indicated by a corresponding one of the one or more objects and the first base point is not more than a predetermined distance. Thus, the information processing apparatus 1A in accordance with the present example embodiment achieves an example advantage of being capable of eliminating a location at which the distance to the first base point is too far, in addition to the example advantage achieved by the information processing apparatus 1 in accordance with the first example embodiment.

The information processing apparatus 1A in accordance with the present example embodiment also employs a configuration in which the constraint condition includes a condition that a distance between a location indicated by a corresponding one of the one or more objects and the base station 2 is not more than a predetermined distance. Thus, the information processing apparatus 1A in accordance with the present example embodiment achieves an example advantage of being capable of eliminating a location at which the distance to the base station is too far, in addition to the example advantage achieved by the information processing apparatus 1 in accordance with the first example embodiment.

The information processing apparatus 1A in accordance with the present example embodiment also employs a configuration in which the obtaining section 11 further obtains radio reflector installation appropriateness information or radio relay apparatus appropriateness information, and the constraint condition includes a condition that a location indicated by a corresponding one of the one or more objects is a location indicated to be acceptable in the radio reflector installation appropriateness information or the radio relay apparatus appropriateness information. Thus, according to the information processing apparatus 1A in accordance with the present example embodiment, it is possible to achieve an example advantage of being capable of eliminating a location where installation of a radio reflector or a radio relay apparatus is not accepted, in addition to the example advantage achieved by the information processing apparatus 1 in accordance with the first example embodiment.

The information processing apparatus 1A in accordance with the present example embodiment also employs a configuration in which the obtaining section 11 obtains first data related to each of a plurality of the first base points, and the constraint condition includes a condition that the one or more locations are calculated such that the number of the one or more locations is minimized. Thus, the information processing apparatus 1A in accordance with the present example embodiment achieves an example advantage of being capable of minimizing the number of locations to be outputted, in addition to the example advantage achieved by the information processing apparatus 1 in accordance with the first example embodiment.

The information processing system 100A in accordance with the present example embodiment also employs a configuration in which the information processing apparatus 1A and the communication apparatus 5 configured to be capable of communicating with the base station 2 are provided, the obtaining section 11 obtaining the first data and the second data in a case where quality of communication in communication between the base station 2 and the communication apparatus 5 is not more than the threshold. Thus, according to the information processing apparatus 1A in accordance with the present example embodiment, it is possible to achieve an example advantage of being capable of outputting information for improving a communication quality in communication between the base station 2 and the communication apparatus 5, in addition to the example advantage achieved by the information processing apparatus 1 in accordance with the first example embodiment.

### Software Implementation Example

Some or all of the functions of each of the information processing apparatuses 1 and 1A may be implemented by hardware such as an integrated circuit (IC chip), or may be alternatively implemented by software.

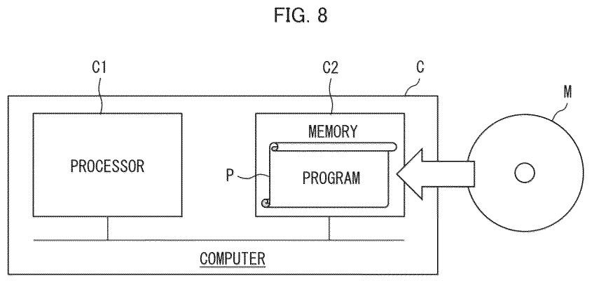

In the latter case, the information processing apparatuses 1 and 1A are implemented by, for example, a computer that executes instructions of a program that is software implementing the foregoing functions. FIG. 8 illustrates an example of such a computer (hereinafter, referred to as “computer C”). The computer C includes at least one processor C1 and at least one memory C2. The memory C2 stores a program P for causing the computer C to operate as the information processing apparatuses 1 and 1A. The processor C1 of the computer C retrieves the program P from the memory C2 and executes the program P, so that the functions of the information processing apparatuses 1 and 1A are implemented.

The processor C1 may be, for example, a central processing unit (CPU), a graphic processing unit (GPU), a digital signal processor (DSP), a micro processing unit (MPU), a floating point number processing unit (FPU), a physics processing unit (PPU), a microcontroller, or a combination thereof. The memory C2 may be, for example, a flash memory, a hard disk drive (HDD), a solid state drive (SSD), or a combination of these.

Note that the computer C may further include a random access memory (RAM) in which the program P is loaded in executing the program P and/or in which various kinds of data are temporarily stored. The computer C may further include a communication interface via which data is transmitted to and received from another apparatus. The computer C may further include an input/output interface for connecting input/output apparatuses such as a keyboard, a mouse, a display, and a printer.

The program P can be recorded in a non-transitory tangible storage medium M from which the computer C can read the program P. The storage medium M can be, for example, a tape, a disk, a card, a semiconductor memory, a programmable logic circuit, or the like. The computer C can acquire the program P via the storage medium M. The program P can be transmitted via a transmission medium. The transmission medium can be, for example, a communications network, a broadcast wave, or the like. The computer C can obtain the program P also via such a transmission medium.

### Additional Remark 1

The present invention is not limited to the above example embodiments, but may be altered in various ways by a skilled person within the scope of the claims. For example, the present invention also encompasses, in its technical scope, any example embodiment derived by appropriately combining technical means disclosed in the foregoing example embodiments.

### Additional Remark 2

Some of or all of the foregoing example embodiments can also be described as below. Note, however, that the present invention is not limited to the following supplementary notes.

### (Supplementary Note 1)

An information processing apparatus including:
obtaining means for obtaining first data and second data, the first data indicating a plurality of objects included in a first angle of field in which a first base point is set at a location at which quality of communication with a base station is not more than a predetermined threshold, the second data indicating a plurality of objects included in a second angle of field in which a second base point is set at the base station;
calculation means for calculating one or more locations each indicated by a corresponding one of one or more objects each indicated in common by both the first data and the second data; and
output means for outputting at least one of the one or more locations calculated by the calculation means.

### (Supplementary Note 2)

The information processing apparatus according to Supplementary note 1, wherein the first data includes first sensing data obtained at the first base point, and the second data includes second sensing data obtained at the second base point.

### (Supplementary Note 3)

The information processing apparatus according to Supplementary note 2, wherein the first sensing data includes first imaging data captured at the first base point; and the second sensing data includes second imaging data captured at the second base point.

### (Supplementary Note 4)

The information processing apparatus according to Supplementary note 2 or 3, wherein the first sensing data includes first point cloud data obtained at the first base point; and the second sensing data includes second point cloud data obtained at the second base point.

### (Supplementary Note 5)

The information processing apparatus according to any one of Supplementary notes 1 to 4, wherein the obtaining means obtains the first data related to a location associated with an event caused in a case where the quality of communication decreases to or below the threshold.

### (Supplementary Note 6)

The information processing apparatus according to any one of Supplementary notes 1 to 5, wherein the output means includes presentation means for presenting at least one of the one or more locations calculated by the calculation means as a radio reflector installation candidate location or a radio relay apparatus candidate location.

### (Supplementary Note 7)

The information processing apparatus according to any one of supplementary notes 1 to 6, wherein the calculation means calculates one or more locations each of which is indicated by a corresponding one of one or more objects each indicated in common by both the first data and the second data, and each of which satisfies a predetermined constraint condition.

### (Supplementary Note 8)

The information processing apparatus according to Supplementary note 7, wherein the constraint condition includes a condition that a distance between a location indicated by a corresponding one of the one or more objects and the first base point is not more than a predetermined distance.

### (Supplementary Note 9 )

The information processing apparatus according to Supplementary note 7 or 8, wherein the constraint condition includes a condition that a distance between a location indicated by a corresponding one of the one or more objects and the base station is not more than a predetermined distance.

### (Supplementary Note 10)

The information processing apparatus according to any one of Supplementary notes 7 to 9, wherein the obtaining means further obtains radio reflector installation appropriateness information or radio relay apparatus appropriateness information, and the constraint condition includes a condition that a location indicated by a corresponding one of the one or more objects is a location indicated to be acceptable in the radio reflector installation appropriateness information or the radio relay apparatus appropriateness information.

### (Supplementary Note 11)

The information processing apparatus according to any one of Supplementary notes 7 to 10, wherein the obtaining means obtains first data related to each of a plurality of the first base points, and the constraint condition includes a condition that the one or more locations are calculated such that the number of the one or more locations is minimized.

### (Supplementary Note 12)

An information processing system including: the information processing apparatus according to any one of Supplementary notes 1 to 11; and a communication apparatus configured to be capable of communicating with the base station, the obtaining means obtaining the first data and the second data in a case where quality of communication in communication between the base station and the communication apparatus is not more than the threshold.

### (Supplementary Note 13)

An information processing method including: obtaining, by at least one processor, first data and second data, the first data indicating a plurality of objects included in a first angle of field in which a first base point is set at a location at which quality of communication with a base station is not more than a predetermined threshold, the second data indicating a plurality of objects included in a second angle of field in which a second base point is set at the base station; calculating, by the at least one processor, one or more locations each indicated by a corresponding one of one or more objects each indicated in common by both the first data and the second data; and outputting, by the at least one processor, at least one of the one or more calculated locations.

### (Supplementary Note 14)

An information processing program for causing a computer to carry out: an obtaining process of obtaining first data and second data, the first data indicating a plurality of objects included in a first angle of field in which a first base point is set at a location at which quality of communication with a base station is not more than a predetermined threshold, the second data indicating a plurality of objects included in a second angle of field in which a second base point is set at the base station; a calculation process of calculating one or more locations each indicated by a corresponding one of one or more objects each indicated in common by both the first data and the second data; and an output process of outputting at least one of the one or more locations calculated in the calculation process.

### Additional Remark 3

Furthermore, some of or all of the above example embodiments can also be expressed as below. An information processing apparatus including at least one processor, the at least one processor carries out: an obtaining process of obtaining first data and second data, the first data indicating a plurality of objects included in a first angle of field in which a first base point is set at a location at which quality of communication with a base station is not more than a predetermined threshold, the second data indicating a plurality of objects included in a second angle of field in which a second base point is set at the base station; a calculation process of calculating one or more locations each indicated by a corresponding one of one or more objects each indicated in common by both the first data and the second data; and an output process of outputting at least one of the one or more locations calculated in the calculation process.

Note that the information processing apparatus may further include a memory, which may store therein a program for causing the at least one processor to carry out the obtaining process, the calculation process, and the output process. Alternatively, the program may be stored in a computer-readable, non-transitory, tangible storage medium.

### REFERENCE SIGNS LIST

1, 1A Information processing apparatus
11 Obtaining section
12 Calculation section
13 Output section

What is claimed is:

1. An information processing apparatus comprising at least one processor, the at least one processor carrying out:
an obtaining process of obtaining first data and second data, the first data indicating a plurality of objects included in a first angle of field in which a first base point is set at a location at which quality of communication with a base station is not more than a predetermined threshold, the second data indicating a plurality of objects included in a second angle of field in which a second base point is set at the base station;
a calculation process of calculating one or more locations each indicated by a corresponding one of one or more objects each indicated in common by both the first data and the second data; and
an output process of outputting at least one of the one or more locations calculated in the calculation process.

2. The information processing apparatus according to claim 1, wherein
the first data includes first sensing data obtained at the first base point, and
the second data includes second sensing data obtained at the second base point.

3. The information processing apparatus according to claim 2, wherein
the first sensing data includes first imaging data captured at the first base point; and
the second sensing data includes second imaging data captured at the second base point.

4. The information processing apparatus according to claim 2, wherein
the first sensing data includes first point cloud data obtained at the first base point; and
the second sensing data includes second point cloud data obtained at the second base point.

5. The information processing apparatus according to claim 1, wherein in the obtaining process, the at least one processor obtains the first data related to a location associated with an event caused in a case where the quality of communication decreases to or below the threshold.

6. The information processing apparatus according to claim 1, wherein in the output process, the at least one processor carries out a presentation process of presenting at least one of the one or more locations calculated in the calculation process as a radio reflector installation candidate location or a radio relay apparatus candidate location.

7. The information processing apparatus according to claim 1, wherein in the calculation process, the at least one processor calculates one or more locations each of which is indicated by a corresponding one of one or more objects each indicated in common by both the first data and the second data, and each of which satisfies a predetermined constraint condition.

8. The information processing apparatus according to claim 7, wherein the constraint condition includes a condition that a distance between a location indicated by a corresponding one of the one or more objects and the first base point is not more than a predetermined distance.

9. The information processing apparatus according to claim 7, wherein the constraint condition includes a condition that a distance between a location indicated by a corresponding one of the one or more objects and the base station is not more than a predetermined distance.

10. The information processing apparatus according to claim 7, wherein
in the obtaining process, the at least one processor further obtains radio reflector installation appropriateness information or radio relay apparatus appropriateness information, and
the constraint condition includes a condition that a location indicated by a corresponding one of the one or more objects is a location indicated to be acceptable in the radio reflector installation appropriateness information or the radio relay apparatus appropriateness information.

11. The information processing apparatus according to claim 7, wherein
in the obtaining process, the at least one processor obtains first data related to each of a plurality of the first base points, and
the constraint condition includes a condition that the one or more locations are calculated such that the number of the one or more locations is minimized.

12. An information processing system comprising:
the information processing apparatus according to claim 1; and
a communication apparatus configured to be capable of communicating with the base station,
in the obtaining process, the at least one processor obtaining the first data and the second data in a case where quality of communication in communication between the base station and the communication apparatus is not more than the threshold.

13. An information processing method comprising:
obtaining, by at least one processor, first data and second data, the first data indicating a plurality of objects included in a first angle of field in which a first base point is set at a location at which quality of communication with a base station is not more than a predetermined threshold, the second data indicating a plurality of objects included in a second angle of field in which a second base point is set at the base station;
calculating, by the at least one processor, one or more locations each indicated by a corresponding one of one or more objects each indicated in common by both the first data and the second data; and
outputting, by the at least one processor, at least one of the one or more calculated locations.

14. A computer-readable non-transitory storage medium storing therein a program for causing a computer to function as the information processing apparatus according to claim 1, the program causing the computer to carry out the obtaining process, the calculation process, and the output process.
